(19) United States
(12) Patent Application Publication
(10) Pub. No.: US 2009/0249346 A1
(43) Pub. Date: Oct. 1, 2009

(54) IMAGE FORMING APPARATUS, INFORMATION PROCESSING APPARATUS AND INFORMATION PROCESSING METHOD

(76) Inventors: Toru Harada, Tokyo (JP); Hidehiko Watanabe, Kanagawa (JP)

Correspondence Address: IPUSA, P.L.L.C, 1054 31ST STREET, N.W., Suite 400, Washington, DC, 20007, US

(21) Appl. No.: 12/410,539

(22) Filed: Mar. 25, 2009

(30) Foreign Application Priority Data
Mar. 27, 2008 (JP) 2008-084508
May 7, 2008 (JP) 2008-121566

(51) Int. Cl. G06F 9/46

(52) U.S. Cl. 718/102; 718/100

(57) ABSTRACT

An image forming apparatus is provided. The image forming apparatus includes: a job reception unit configured, in response to an execution request for a job, to receive a second program in which an insertion process for a first program that executes the job is described or to receive identification information of the second program; an application unit configured to apply the second program to the first program loaded in a memory; and a job execution unit configured to execute the job based on the first program to which the second program is applied.

### BACKGROUND OF THE INVENTION

1. Field of the Invention

The present invention relates to an image forming apparatus, an information processing apparatus, and an information processing method.

2. Description of the Related Art

Conventionally, various kinds of functions are realized by software control in an image forming apparatus such as a printer, a copy machine, a facsimile, a multifunctional machine and the like. In some image forming apparatuses, implementation specifications of software are disclosed so that third party vendors can customize the software (function of the image forming apparatus). For these image forming apparatuses, it is possible to add user specific functions according to the business of the user. Japanese Laid-Open Patent Application No. 2004-139572 discloses a related art of software customization.

However, in conventional customization, it is necessary to change software configuration in the image forming apparatus. For example, it is necessary to add new programs, or to modify existing programs. Therefore, work such as installing a new program needs to be performed by a service man and the like, and there is a problem in that a cost for the work occurs.

In addition, the result of the customization is commonly applied to all users and all jobs. Thus, when there is a user who wants to continually use a function that is not customized, it is necessary to modify the program such that both functions before and after customization can be used. Therefore, there are problems in that source code of the program becomes complicated, development cost increases, and possibility of occurrence of programming bugs increases.

The present invention was conceived in view of the above-mentioned problems, and an object of the present invention is to provide an image forming apparatus, an information processing apparatus and an information processing method that can provide a new customization mechanism for implemented functions.

### SUMMARY OF THE INVENTION

For solving the above-problem, according to an embodiment of the present invention, an image forming apparatus can be configured to include: a job reception unit configured, in response to an execution request for a job, to receive a second program in which an insertion process for a first program that executes the job is described or to receive identification information of the second program; an application unit configured to apply the second program to the first program loaded on a memory; and a job execution unit configured to execute the job based on the first program to which the second program is applied.

According to the embodiment, a new customization mechanism for implemented functions can be provided.

### BRIEF DESCRIPTION OF THE DRAWINGS

Other objects, features and advantages of the present invention will become more apparent from the following detailed description when read in conjunction with the accompanying drawings, in which:

FIG. 1 is a diagram showing a configuration example of an image forming system according to a first embodiment of the present invention;

FIG. 2 is a diagram for describing outline of the add program;

FIG. 3 is a diagram showing an example of a hardware configuration of the apparatus 20 of an embodiment of the present invention;

FIG. 4 is a sequence diagram for explaining a processing procedure when executing a print job according to a first example in the first embodiment;

FIG. 5 is a diagram showing a display example of the print setting screen;

FIG. 6 is a diagram showing a display example of an add program list screen;

FIG. 7 is a diagram showing a configuration example of the add program use reservation data;

FIG. 8 is a diagram showing a configuration example of the print data;

FIG. 9 is a diagram showing a configuration example of the add program sending command data;

FIG. 10 is a diagram showing a configuration example of the add program halt command data;

FIG. 11 is a sequence chart for explaining the processing procedure of the copy job in the first example;

FIG. 12 is a diagram showing a display example of an add program list screen on the operation panel of the apparatus;

FIGS. 13A and 13B show a sequence diagram for explaining a processing procedure when executing the print job in a second example of the first embodiment;

FIG. 14 is a diagram showing a configuration example of an apparatus management system according to a second embodiment of the present invention;

FIG. 15 is a diagram showing a software configuration example of the apparatus 120 of the second embodiment of the present invention;

FIG. 16 is a flowchart for explaining processes for applying the add program according to a first example of the second embodiment;

FIG. 17 schematically shows comparison of owner information;

FIG. 18 is a flowchart for explaining processes for applying the add program in the second example;

FIG. 19 is a diagram showing a configuration example of the application availability determination table;

FIG. 20 is a flowchart for explaining processes for applying the add program in the third example; and

FIG. 21 is a diagram showing a configuration example of the exclusive relationship management table.

### DETAILED DESCRIPTION OF THE PREFERRED EMBODIMENTS

In the following, embodiments of the present invention are described with reference to figures.

### First Embodiment

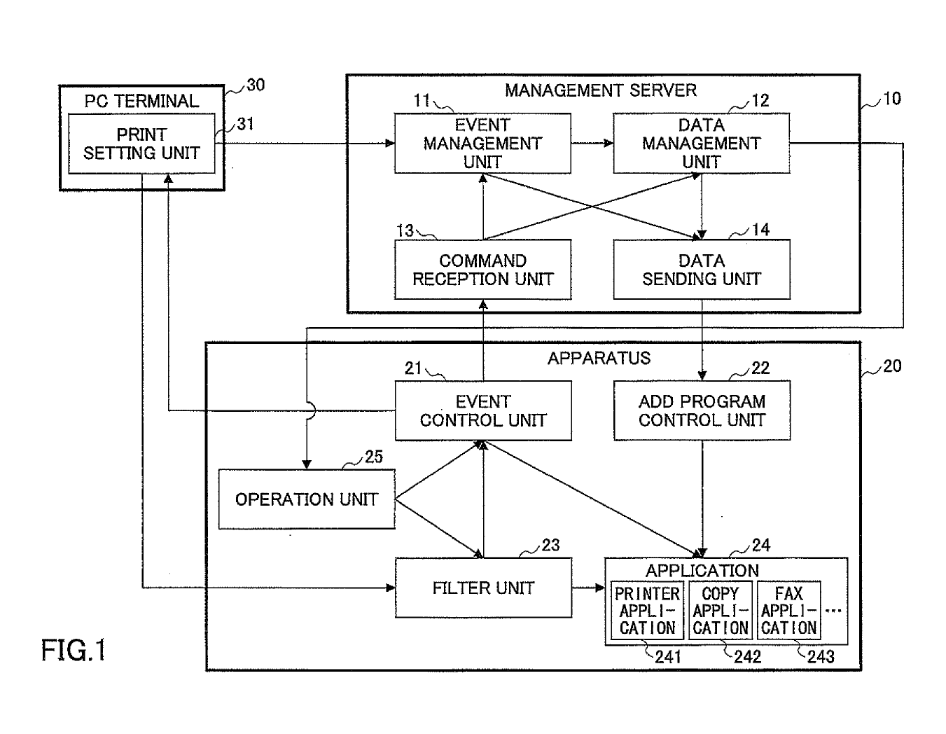

FIG. 1 is a diagram showing a configuration example of an image forming system according to a first embodiment of the present invention. In the image forming system shown in FIG. 1, a management server 10, an apparatus 20, and a PC terminal 30 are connected via a network (including wireless network and/or cable network) such as a LAN (Local Area Network) or the Internet.

The apparatus 20 is an image forming apparatus (multifunctional machine) realizing a plurality of functions such as copy function, printer function and scanner function in a body. The function of the apparatus 20 described in embodiments of the present invention can be realized by a program installed in the apparatus 20. The program can be stored in a computer readable recording medium from which the program can be installed in the apparatus 20.

The PC terminal 30 is a computer (PC (Personal Computer)) used for inputting jobs (mostly print jobs) in the apparatus 20. The function of the PC terminal 30 described in embodiments of the present invention can be realized by a program installed in the PC terminal 30. The program can be stored in a computer readable recording medium from which the program can be installed in the PC terminal 30.

The management server 10 is computer for performing management of add programs to be applied to programs used in the apparatus 20, and performing transfer of the add programs to the apparatus 20, and the like. In the present embodiment, the add program is a program that can dynamically insert a process defined in the add program at an arbitrary point of a program which is an application target on the memory. The application target of an add program is a program to which the add program is applied.

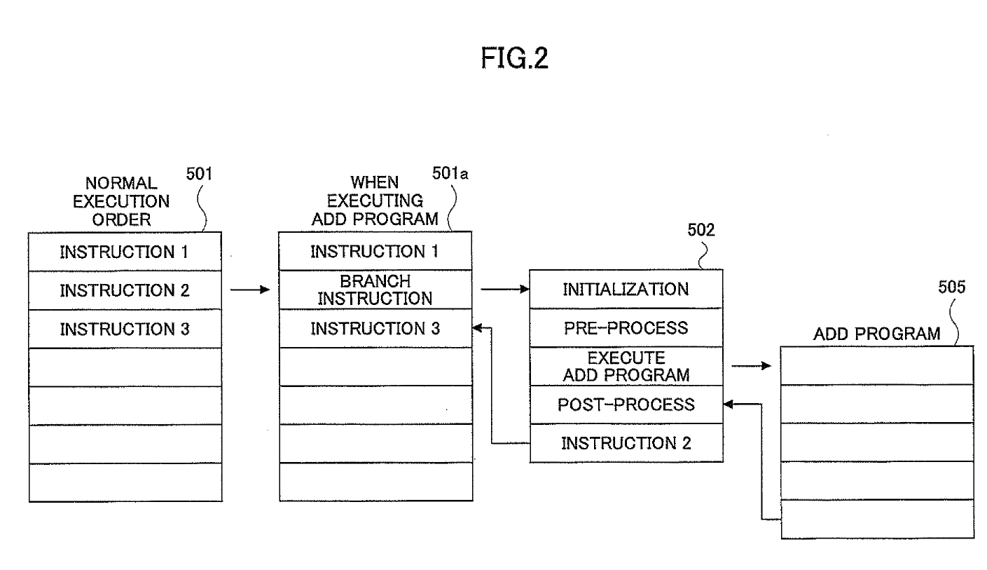

FIG. 2 is a diagram describing an outline of the add program. In FIG. 2, 501 indicates an array of instructions in a virtual memory in a program to which the add program 505 is applied. Before the add program 501 is provided (when the program is exacted without the add program 501), the program 501 performs processes in an order of instructions 1, 2 and 3. Table 501a shows a state in which the add program 501 is applied to the program 501. In this example, processes of the add program 505 are inserted between the instruction 1 and the instruction 2. In this case, the instruction 2 is replaced with a branch instruction. The table 502 defines a procedure for performing initialization process, pre-process (saving variables on stacks, for example), process for calling the add program 505, post-process (extracting variables saved on stack, for example), and the instruction 2, and after that, returning to the instruction 3 of the program 501.

That is, when the add program is applied, when execution step of the program to which the add program is applied reaches a predetermined point (add position), the processes of the add program are executed. After processes of the add program end, process control returns to the program of the application target. After that, the application target program restarts processes from the add position. The add program includes information for identifying the add position in addition to code for the processes inserted into the target program.

In the add program, variables of the program of the application target can be referred to. Therefore, the add program can insert, into the program of the application target, a process for outputting log information indicating a variable value at an arbitrary point of the program of the application target, a process for realizing a new function, or the like.

In the present embodiment, the add program is used as a measure configured to temporarily (for each job) customize an application program performing a job in the apparatus 20.

Next, a functional configuration of each apparatus is described with reference to FIG. 1. In the figure, the management server 10 includes an event management unit 11, a data management unit 12, a command reception unit 13, and a data sending unit 14 and the like.

The event management unit 11 controls processes according to an event (such as a request and a command) input from an external part (the apparatus 20 or the PC terminal 30). The data management unit 12 manages add programs using a recording medium of the management server 10. That is, the recording medium of the management server 10 stores various kinds of add programs for extending or customizing functions of jobs executed in the apparatus 20. The command reception unit 13 receives a command requesting control of the add program control unit 22 from the event control unit 21 of the apparatus 20. The data sending unit 14 sends an add program or a control instruction according to the command received by the command reception unit 13 to the add program control unit 22 of the apparatus 20. In the present embodiment, only the data sending unit 14 knows an interface and a protocol for controlling or operating the add program control unit 22.

The apparatus 20 includes an event control unit 21, an add program control unit 22, a filter unit 23, an application 24, and an operation unit 25 and the like.

The application 24 is an application program for controlling execution of various kinds of jobs input to the apparatus 20. As an example, the figure shows an printer application 241 for controlling print jobs, a copy application 242 for controlling copy jobs, and a FAX application 243 for controlling FAX sending jobs.

The filter unit 23 performs filtering for various kinds of input jobs, and sends an execution request to the application 24 at a timing according to the result of filtering. That is, the job input to the apparatus 20 is sent to the filter unit 23 before it is sent to the application 24. Filtering in this example is to identify or differentiate between a job for which application of the add program is designated and a job for which application of the add program is not designated. That is, as to a job for which application of the add program is designated, the filter unit 23 requests the event control unit 21 to apply the add program to the application 24 before requesting the application 24 to execute the job. In addition, the filter unit 23 can detect completion of the job based on a response for a print request for the application 24. In response to the detection of completion of the job, the filter unit 23 requests the event control unit 21 to release application of the add program. Necessity to apply an add program to the application 24 and an add program to be used are designated in the execution request of the input job.

In response to a request (application request or release request for the add program) from the filter unit 23, the event control unit 21 sends, to the command reception unit 13, a command for causing the add program control unit 22 to execute a process based on the request. The reason for sending the command to the management server 10 is that the data sending unit 14 of the management server 10 knows an interface and a protocol for controlling or operating the add program control unit 22.

In response to a command from the data sending unit 14 of the management server 10, the add program control unit 22 applies or releases the add program for the application 24 loaded on the memory. In the present embodiment, the add program control unit 22 can be controlled by the data sending unit 14 since the add program control unit 22 is a program module based on remote operation (operation via a network).

The operation unit 25 performs input and output control of the operation panel of the apparatus 20.

The PC terminal 30 includes a print setting unit 31. The print setting unit 31 is realized by a program generally called a printer driver. That is, the print control unit 31 causes the apparatus 20 to display a screen for inputting settings for print data (such as document data) generated or edited by various applications on the PC terminal 30, or to generate print data that can be interpreted by the printer application 241 of the apparatus 20 based on the settings of the print setting screen. The print data of the present embodiment corresponds to job data for requesting the apparatus 20 to execute the print job.

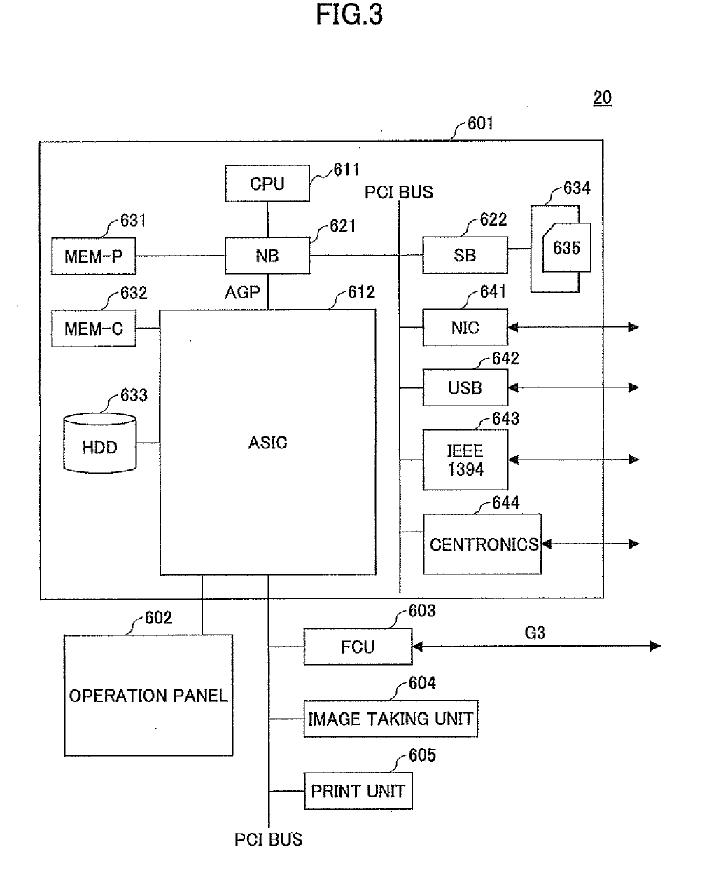

FIG. 3 is a diagram showing an example of a hardware configuration of the apparatus 20 of an embodiment of the present invention. As shown in the diagram, the apparatus 20 includes a controller 601, an operation panel 602, a facsimile control unit (FCU) 603, an image taking unit 604 and a print unit 605 and the like.

The controller 601 includes a CPU 611, an ASIC 612, a NB 621, a SB 622, a MEM-P 631, a MEM-C 632, a HDD (hard disk drive) 633, a memory card slot 634, NIC (network interface controller) 641, a USB device 642, an IEEE 1394 device 643, and a Centronics device 644.

The CPU 611 is an IC for various information processing. The ASIC 612 is an IC for various kinds of image processing. The NB 621 is a north bridge of the controller 601. The SB 622 is a south bridge of the controller 601. The MEM-P 631 is a system memory of the apparatus 20. The MEM-C 632 is a local memory of the apparatus 20. The HDD 633 is a storage of the apparatus 20. The memory card slot 634 is a slot for setting the memory card 635. The NIC 641 is a controller for network communication using MAC address. The USB device 642 is a device for providing connection terminal of USB standard. The IEEE 1394 device 643 is a device for providing a connection terminal of Centronics specification. The operation panel 602 is hardware (operation unit) for the operator to input data, and hardware (display unit) for the operator to obtain outputs from the apparatus 20.

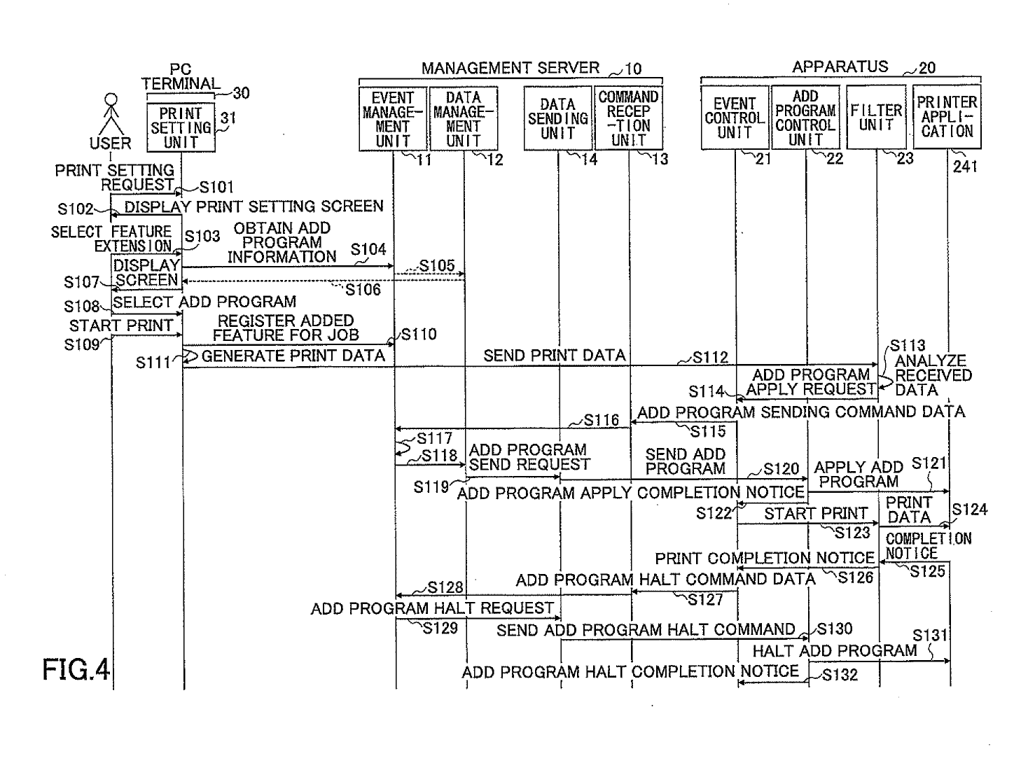

In the following, a processing procedure of the image forming system 1 is described. FIG. 4 is a sequence diagram for explaining a processing procedure when executing a print job according to a first example.

When a user inputs a display request to the print setting unit 31 on the PC terminal 30 in order to print document data in step S101, the print setting unit 31 displays a print setting screen on a display device of the PC terminal 30 in step S102.

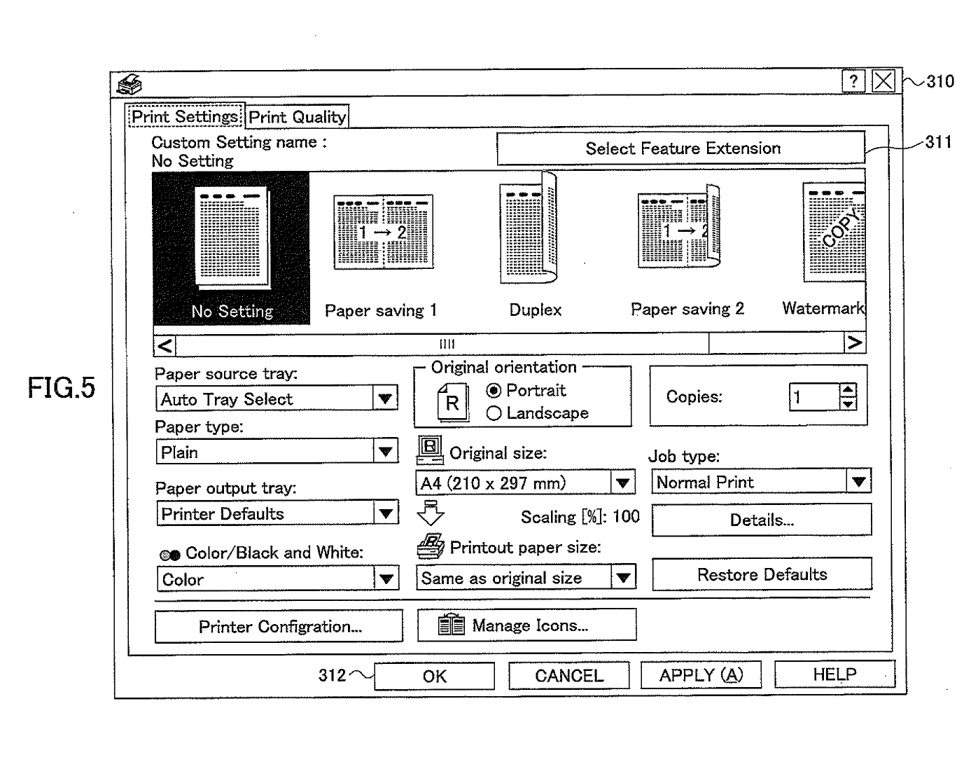

FIG. 5 is a diagram showing a display example of the print setting screen. In the diagram, the print setting screen 310 is a screen for inputting various print settings (print conditions). Except for the feature extension button 311, setting items are basically general ones.

When the feature extension button 311 is pushed (clicked), the print setting unit 31 sends a request to the management server 10 to obtain list information of add programs for realizing feature extension (which can be also referred to as “function extension”) in step S104. The request may include information for specifying add programs that can be applied (used) such as identification information of the model of the apparatus 20 or a name (application name) of the printer application 241. The identification information of the model of the apparatus 20 and the application name of the printer application 241 and the like can be obtained by contacting the apparatus 20 when the print setting unit 311 displays the print setting screen 510.

When the event management unit 11 of the management server 10 receives the obtaining request of the add program, the event management unit 11 requests the data management unit 12 to return list information of add programs that are managed in step S105. The data management unit 12 generates the list information of the managed add programs to return the list information to the print setting unit 31 in step S106. In the present embodiment, the list information is a list of character strings indicating identification information and functions of the add programs, for example. In addition, the identification information indicates add program numbers. When the obtaining request of add programs includes information for specifying applicable add programs, the data management unit 12 generates list information of add programs corresponding to the information for specifying applicable add programs. For realizing such function, the data management unit 12 manages in a recording medium information that can identify applicable targets (models of apparatus 20, application name of the printer application 241, and the like) for each add program.

When the print setting unit 31 receives list information of the add programs, the list information is displayed in step S107.

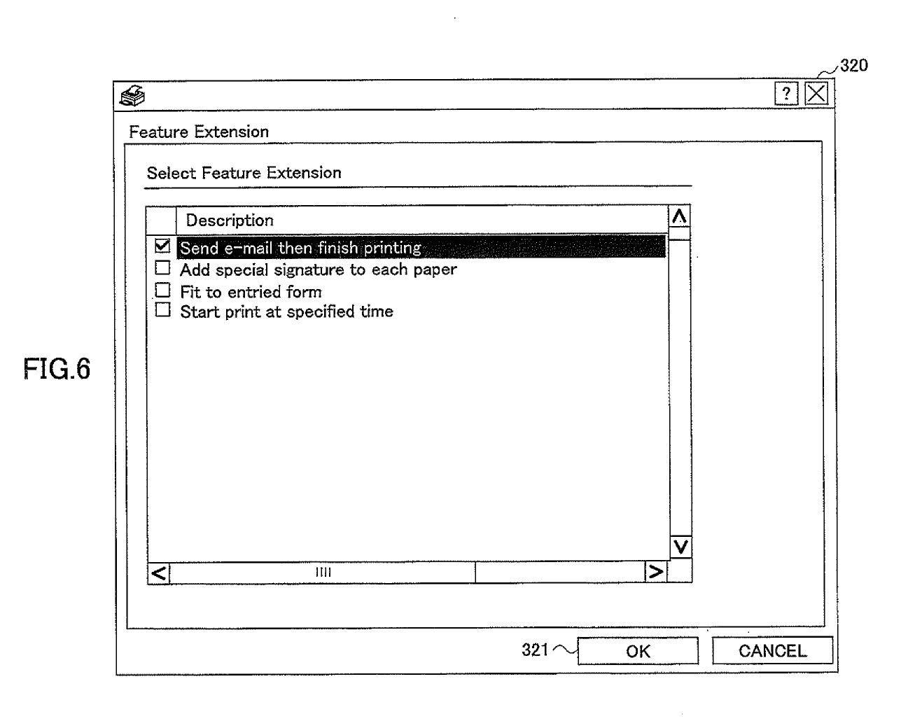

FIG. 6 is a diagram showing a display example of an add program list screen. In the figure, a list of character strings indicating function of each add program is displayed. As an example, the figure shows “Send e-mal then finish printing”, “Add special signature to each paper”, “Fit to registered form” and “Start print at specified time”.

A desired add program is selected as a use subject from among the list by the user in step S108, and, OK button 321 of the add program list screen 320 and OK button 312 of the print setting screen 310 are pushed so that a print start instruction is input in step S109, the print setting unit 31 sends add program use reservation data to the management server 10 in step S110.

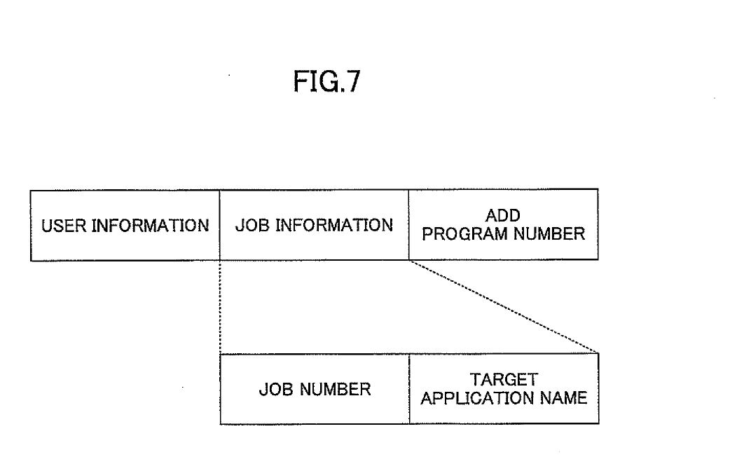

FIG. 7 is a diagram showing a configuration example of the add program use reservation data. As shown in the figure, the add program use reservation data includes user information, job information, add program number and the like. The user information is identification information (user name, for example) of a login user for the PC terminal 30. The print setting unit 31 contacts OS and the like of the PC terminal 30 to get the user information. The job information includes a job number and a target application name. The job number is a number for identifying a print job, and the number is assigned by the print setting unit 31. The target application name is an application name of an application for which an add program is applied, that is, the target application name is an application name of the printer application 241. The add program number is an add program number of an add program to be applied. That is, the add program use reservation data is data indicating correspondence among users for, job number, and add program for the print job. The event management unit 11 of the management server 10 receives the add program user reservation data and stores it in a recording medium.

Next, the print setting unit 31 generates print data based on print setting and the like in step S111. In the process, the print setting unit 31 includes information on the add program to be used in the print data.

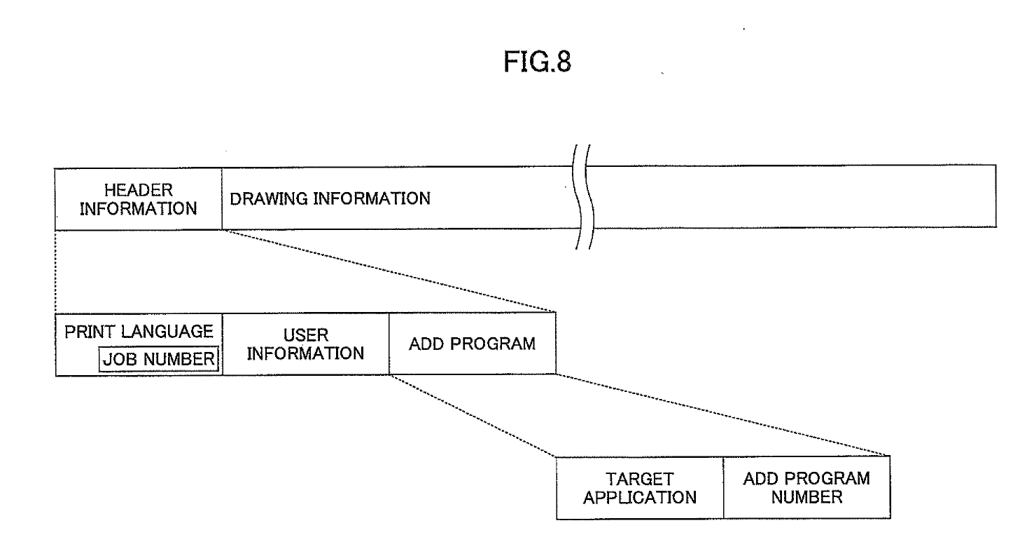

FIG. 8 is a diagram showing a configuration example of the print data. As shown in the figure, the print data includes header information and drawing information. The drawing information is drawing information of a document which is the print object. The header information includes print language information, user information and add program information. The print language information includes various definitions (print settings, for example) used by a printer language (such as PDL (Page Description Language). The print language information includes the job number. The user information is the same as the above-mentioned user information. The add program information is information added when use of the add program is designated, and includes the target application name and the add program number. Meanings of the target application name and the add program number are the same as those mentioned above.

Next, the print setting unit 31 sends the generated print data to the apparatus 20 in step S112. When the print data is received by the apparatus 20, the filter unit 23 analyzes the print data in step S113. In the analysis, the presence or absence of add program information is determined, and when there is the add program information, the contents are analyzed. When there is no add program information, the filter unit 23 outputs the print data as it is to the printer application 241. The printer application 241 executes a normal print job (with no function extension by the add program) based on the print data.

On the other hand, when the print data includes add program information, the filter unit 23 requests the event control unit 21 to apply the add program by sending the add program information, and the user information and the job number that are included in the print data in step S114. Next, the event control unit 21 sends command data (add program sending command data) to the command reception unit 13 of the management server 10 for requesting transmission of the add program to the add program control unit 22 in step S115.

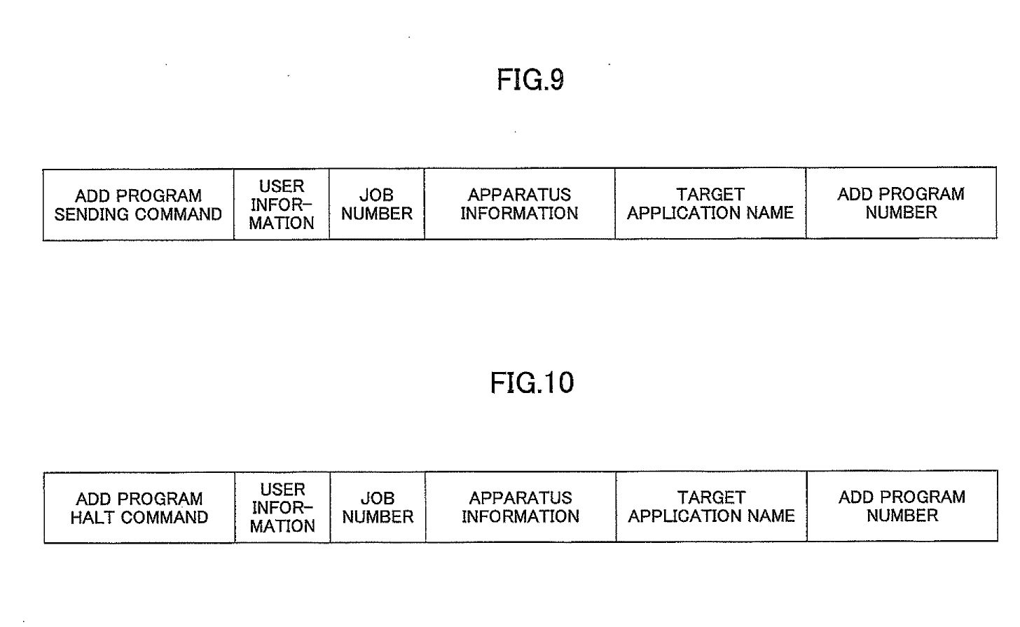

FIG. 9 is a diagram showing a configuration example of the add program sending command data. As shown in the figure, the add program sending command data includes the add program sending command, user information, the job number, apparatus information, the target application name, and the add program number.

The add program sending command is a numerical value or a character string indicating that the command data is a sending request of the add program. Information sent from the filter unit 23 are set as they are into “user information”, “job number”, “target application name” and “add program number”, and they are used for specifying the add program for which sending is requested. The apparatus information is identification information (IP address, host name, or the like) of the apparatus 20 on the network.

The command reception unit 13 passes the received add program sending command data to the event management unit 11 in step S116. The event management unit 11 checks whether there is add program use reservation data (FIG. 7), in the recording medium of the management server 10, corresponding to the user information, the job number, the target application name and the add program number that are specified by the add program sending command data in order to check whether the PC terminal 30 has requested (reserved) the use of the add program for which the apparatus 20 requested to send in step S117.

When the corresponding add program use reservation data exists, the event management unit 11 passes the add program sending command data to the data management unit 12 to request the data management unit 12 to send the add program in step S118. The data management unit 12 obtains the add program corresponding to the add program number included in the add program sending command data from the recording medium of the management server 12, and sends the add program and the add program sending command data to the data sending unit 14 in step S119. The data transmission unit 14 sends the add program data, and the add program number and the target application name included in the add program sending command data to the add program control unit 22 of the apparatus 20 in order to request the add program control unit 22 to apply the add program to the application 24 (printer application 241 in this example) corresponding to the target application name in step S120. The apparatus 20 to which the add program is sent is determined based on apparatus information included in the add program sending command data.

When the add program control unit 22 receives the add program, the add program number and the target application name, the add program control unit 22 applies the add program to the printer application 241 corresponding to the target application name on the memory in step S121. More particularly, as described in FIG. 2, the add program control unit 22 inserts the process of the add program at the position specified in the add program in process steps of the printer application 241 in the memory. After the application of the add program completes, the add program control unit 22 notifies the event control unit 21 of the completion of application of the add program in step 122. The add program control unit 22 manages (identifies) the add program applied to the printer application 241 using the add program number.

When the event control unit 21 receives the notification, the event control unit 21 instructs the filter unit 23 to start a print job in step S123. The filter unit 23 outputs print data received in step S112 to the printer application 241 in step S124. The printer application 241 executes the print job based on the print data. When the print job completes, the printer application 241 sends a response to the filter unit 23 in step S125. The response includes information indicating success or failure of the print job, for example.

Next, the filter unit 23 notifies the event control unit 21 of completion of the print job in step S126. In response to the completion of the print job, the event control unit 21 sends command data (add program halt command data) requesting a halt (release of application) of the add program applied to the print job to the command reception unit 13 of the management server 10 in step S127.

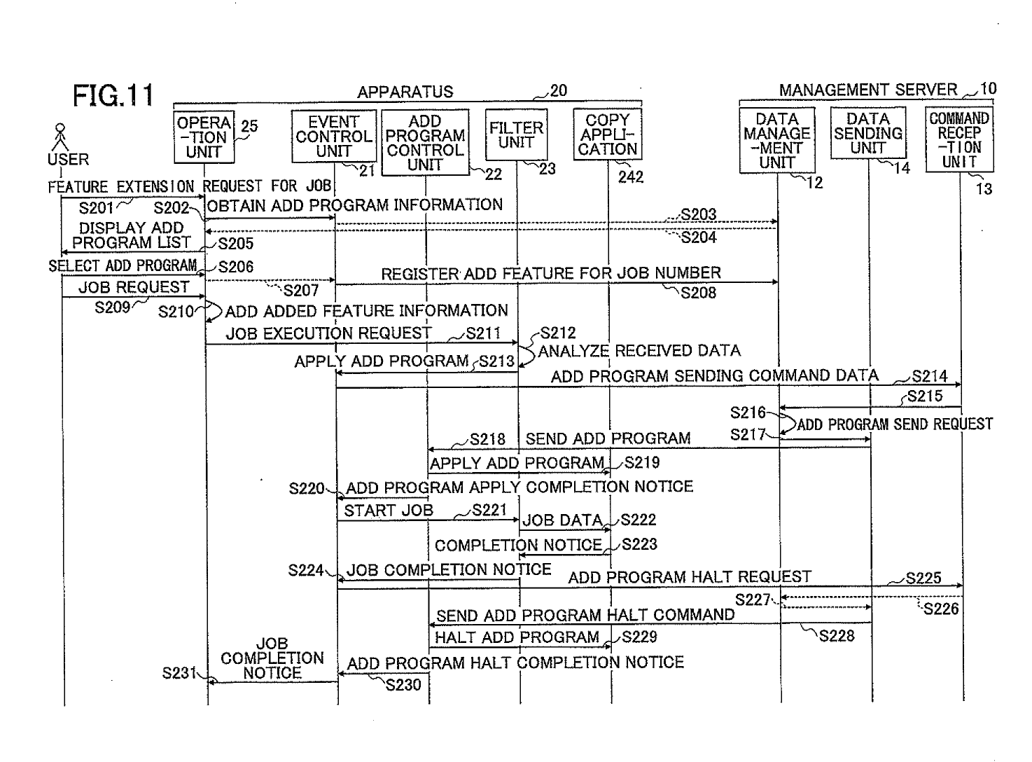

FIG. 10 is a diagram showing a configuration example of the add program halt command data. As shown in the figure, the add program halt command data includes add program halt command, user information, job number, apparatus information, target application name and add program number.

The add program halt command is a numeric value or a character string indicating that the command data is a halt request for the add program. Values set as the user information, the job number, the target application name and the add program number are the same as the values set for the add program sending command.

The command reception unit 13 sends the received add program halt command data to the event management unit 11 in step S128. The event management unit 11 sends the add program halt command data to the data sending unit 14 in order to request the data sending unit 14 to halt the add program in step S129. The data sending unit 14 sends, to the add program control unit 22 of the apparatus 20, the add program halt command with the add program number and the target application name included in the add program halt command data in step S130.

When the add program control unit 22 receives the add program halt command, the add program number and the target application name, the add program control unit 22 halts the add program applied to the printer application 241 based on the add program number and the target application name in step 3131. Accordingly, the add program is unloaded from the memory, and the processing procedure of the printer application 241 returns to the state before the add program is applied. Next, the add program control unit 22 notifies the event control unit 21 that the halt of the add program completes in step S132. In response to receiving the notification, the event control unit 21 detects that the process on the print job ends. That is, the event control unit 21 ascertains not only that the print job completes but also that information on the add program is deleted.

In the above-processes, although an example is described in which the print data includes information (add program number) for identifying the add program, the body of the add program may be included in the print data. In addition, the event control unit 21 or the filter unit 23 may executes the control process (such as add program sending process and halt instruction of the add program) of the add program control unit 22. In this case, in the apparatus 20 side, it becomes unnecessary to perform processes for obtaining the add program from the management server 10 and processes for requesting the management server 10 to apply and halt the add program.

In the above embodiment, although the print job is explained as a job input from the PC terminal 30, the job input from the PC terminal 30 may be a FAX transmission job, for example. In this case, the apparatus 20 is requested to transmit document data stored in the PC terminal 30 via the network. Also as to such a FAX transmission job, function strengthening (customizing) can be realized using the add program by processing procedure similar to that shown in FIG. 4.

Function extension by the add program is not limited to the print job input from the PC terminal 30. For example, function extension is also possible for a copy job or a FAX transmission job input via the operation panel 602 of the apparatus 20.

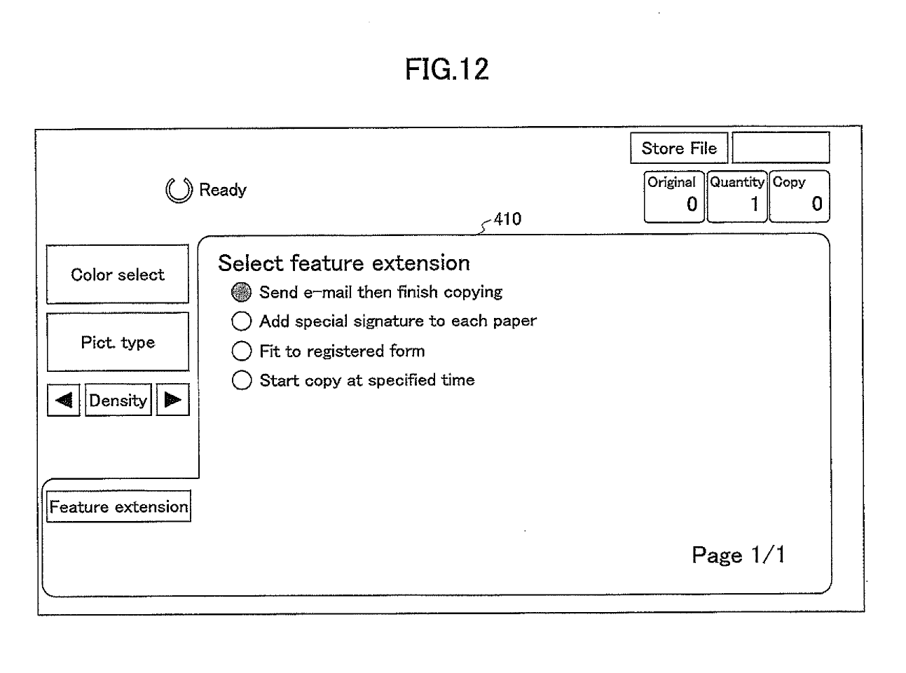

FIG. 11 is a sequence chart for explaining the processing procedure of the copy job in the first example. Meanings of terms used in the following are the same as those described in description for FIG. 4 unless otherwise specified.

The copy application 242 is selected as a use subject on the operation panel 602, and a predetermined button (feature extension button) is pushed by a user on the copy setting screen so that a function extension request is input in step S201. Then, the operation unit 25 requests the event control unit 21 to obtain list information of add programs realizing function extension in step S202. The event control unit 21 sends a request for obtaining the list information of the add programs to the management server 10 in step 203. The request may include information specifying the add program that can be applied (used) such as identification information of the model of the apparatus 10 and the application name of the printer application 241 and the like. When the data management unit 12 of the management server 10 receives the obtaining request of the add program, the data management unit 12 generates list information of the managed add programs and returns the list information to the operation unit 25 in step S204.

When the operation unit 25 receives the list information of the add programs, the operation unit 25 displays the list information on the operation panel 602 in step S205.

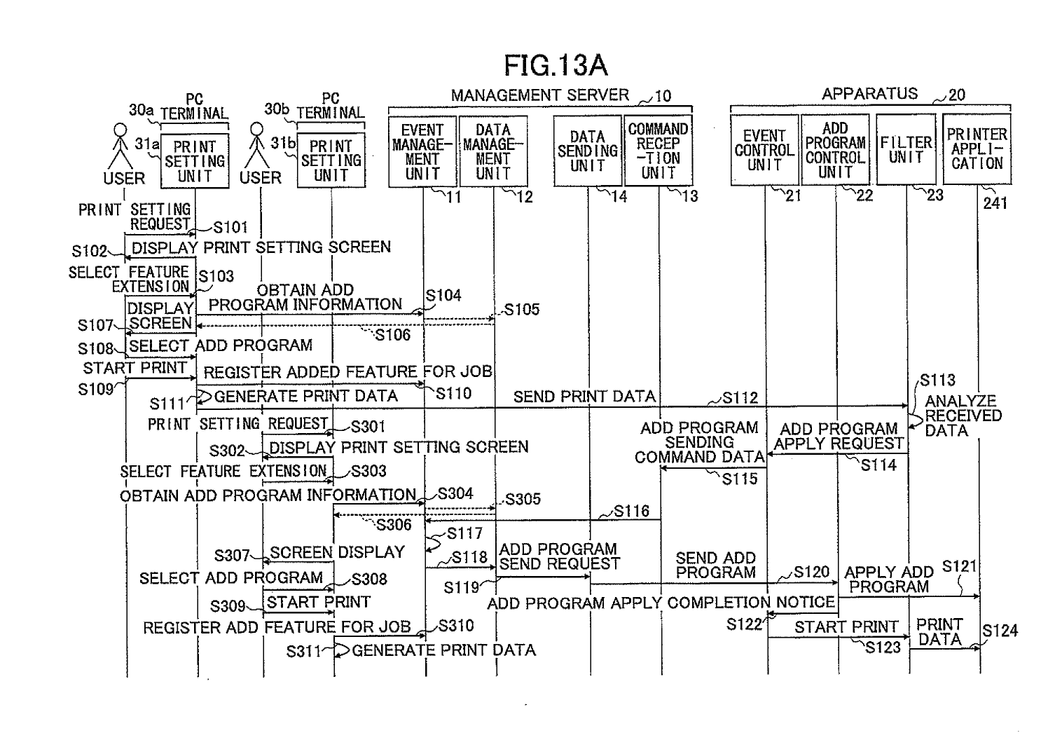

FIG. 12 is a diagram showing a display example of an add program list screen on the operation panel of the apparatus. As shown in the figure, the add program list screen 320 displays a list of character strings indicating functions of each add program. As an example, the figure shows “Send e-mail then finish copying”, “Add special signature to each paper”, “Fit to registered form” and “Start copy at specified time” and the like.

When a desired add program is selected as a use subject from among the list in step S206, the operation unit 25 sends add program use reservation data (refer to FIG. 7) to the management server 10 via the event control unit 21 in steps S207 and S208. The user information included in the add program use reservation data is user information of a login user for the apparatus 20. In addition, the job number is assigned by the operation unit 25 or the event control unit 21 or the like. The target application name is the application name of the copy application 242. The data management unit 12 of the management server 10 receives the add program use reservation data and stores the data in a recording medium.

Next, when a start button is pushed so that a start instruction of copy is input in step S209, the operation unit 25 adds information (target application name and add program number and the like) on the add program selected as the use subject to job data of the copy job in step S210. The job data includes a job number and setting information and the like for the copy job. Next, the operation unit 25 sends the job data to the filter unit 23 in order to request execution of the copy job in step S211.

The processing procedure after that is almost similar to processing procedure after step S113 in FIG. 4 except that the application 24 for executing the job (that is, application 24 to which the add program is applied) is the copy application 242.

There is a possibility that a print job is input (received) in parallel while other print job is being executed in the apparatus 20. In addition, there is a possibility that application of different add programs is requested for the two print jobs respectively. In this case, when the add programs are applied simultaneously, unintended result may be output for each print job. This is because a plurality of add programs can be applied to one program at the same time. In the following second example, an example for solving the problem is described.

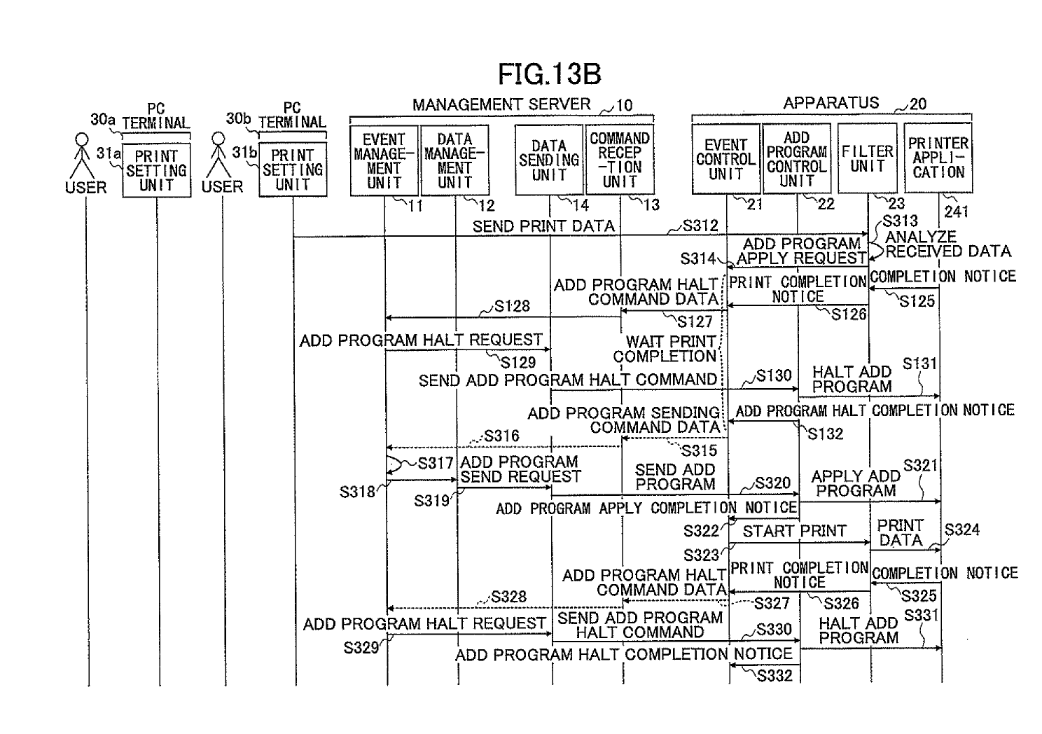

FIGS. 13A and 13B show a sequence diagram for explaining a processing procedure when executing the print job in the second example. FIGS. 13A and 13B show a processing procedure in a case where a print job B is input from the print setting unit 31b of the PC terminal 30b after a print job A is input from the print setting unit 31a of the PC terminal 30a and before the print job A completes. In the figure, similar to FIG. 4, step numbers of 100s are assigned to the processing procedure for the print job A. Step numbers of 300s are assigned to the processing procedure for the print job B. In this case, the processing procedure for each print job is the same as that described in FIG. 4. Therefore, the following explanation is focused on points that should be specifically noted in FIGS. 13A and 13B.

In the figure, when the event control unit 121 of the apparatus 20 instructs the filter unit 23 to execute the print job A in step S123, the event management unit 121 stores, in the memory, information indicating that a job is being executed for each type of the job or the application 24. The type identifies a print job (printer application 241), a copy job (copy application 242), or a FAX transmission job (FAX application 243), or the like. More particularly, in this process, the value of flag variable indicating whether the print job is being executed is set to be ON.

After that, the filter unit 23 outputs print data A of the print job A to the printer application 241 in step S124. After that, the filter unit 23 receives print data B of the print job B from the print setting unit 31b in step S312. The filter unit 23 analyzes the print data B. When add program information is added, the filter unit 23 requests the event control unit 21 to apply the add program in step S314.

The event control unit 21 that revives the request determines whether other print job is being executed based on the flag variable. In this example, the value of the flag variable is ON based on the execution instruction of the print job A. Therefore, the event control unit 21 waits until receiving completion notification of the print job A (S126) and receiving halt completion notification (S132) for the add program from the add program control unit 22. Then, the event control unit 21 sends add program sending command data for the print job B to the command reception unit 13 of the management server 10 in step S315. When the event control unit 21 receives the halt completion notification of the add program for the job A, the event control unit 21 sets the flag variable to OFF.

According to the above-processes, it can be avoided that an add program specified for the print job B is applied to the printer application 241 when the print job A is being executed, and that an add program specified for the print job A is continued to be applied to the printer application 241 when the print job B starts to be executed, for example. Therefore, for each of the print job A and print job B, it can be avoided that unintended function strengthening is applied.

When the event control unit 21 receives, from the filter unit 23, an application request of an add program for a job of a different type of job when the different type of job is being executed, the event control unit 21 may send the add program sending command data to the management server 10 without waiting. When the types of jobs are different, applications 24 (target applications) to which add programs are applied are also different. Thus, there is no possibility of interference between add programs. However, there is a case in which a common program module is used in different applications 24. In such program configuration, if there is a possibility that the add program is applied to the common program module, the event control unit 21 awaits application of the add program until the other job completes as described in FIGS. 13A and 13B even though the types of jobs are different.

As described above, according to the image forming system 1 of the present embodiment, the processing procedure of an application program that is executing a job can be dynamically changed in units of job. Therefore, each function can be customized or can be strengthened in units of job.

In addition, since a period during which the add program is applied is limited in units of job, an effect by an add program that is requested to be applied to another job can be properly avoided for execution of each job.

Features of a method and a computer readable medium of the first embodiment can be represented by the following listed configurations.

The method is an information processing method executed by an information processing apparatus for requesting an image forming apparatus connected via a network to execute a job, including: displaying a screen for inputting settings for the job; and sending job data to the image forming apparatus, wherein the job data includes the settings input via the setting screen, and includes a second program in which an insertion process for a first program that executes the job in the image forming apparatus is described or identification information of the second program.

The computer readable recording medium is a computer readable recording medium storing a program for causing an image forming apparatus to function as: a job reception unit configured, in response to an execution request for a job, to receive a second program in which an insertion process for a first program that executes the job is described or to receive identification information of the second program; an application unit configured to apply the second program to the first program loaded on a memory; and a job execution unit configured to execute the job based on the first program to which the second program is applied.

The computer readable recording medium may include: a release unit configured to release application of the second program to the first program according to completion of the job.

In the computer readable recording medium, when another job is being executed based on the first program, the application unit may wait for applying the second program until the other job completes.

In the computer readable recording medium,, wherein the job reception unit may receive job data including the second program or the identification information of the second program from a computer connected via a network.

In the computer readable recording medium, the program may further causes the image forming apparatus to function as: a list displaying unit configured to receive list information of the second program from a computer connected via a network and to cause an operation panel to display the list information, wherein the job reception unit receives the identification of the second program after the second program is selected from among the list information.

The computer readable recording medium can be also configured as a computer readable recording medium storing a program for causing an information processing apparatus for requesting an image forming apparatus connected via a network to execute a job to function as: a setting screen displaying unit configured to display a screen for inputting settings for the job; and a job data sending unit configured to send job data to the image forming apparatus, wherein the job data includes the settings input via the setting screen, and includes a second program in which an insertion process for a first program that executes the job in the image forming apparatus is described or identification information of the second program.

### Second Embodiment

In general, analysis of logs output from a program is performed as typical work for failure analysis (debugging) of the program that is executed in an embedded apparatus and the like. More particularly, source code of the program includes, in various points, instructions (printf instruction in C language, for example) for outputting to a log file values of variables used by the program and information indicating status of hardware on which the program is operating. When failure occurs, by analyzing the log file output according to the instructions, cause of the failure can be estimated or specified.

However, in many cases, the log file (initially output log file) output by the log output instructions embedded in the program beforehand is not enough for performing detailed analysis. In these cases, based on the initially output log file, failure parts are narrowed to some extent. Next, source code of the program is modified, compiled and linked such that the program outputs more detailed logs around the narrowed failure parts. Then, the program is replaced with the modified program. When the cause cannot be specified even by a log file output by the modified program, log output instructions are further embedded to the source code, and the above-mentioned work is repeated. Accordingly, for performing failure analysis based on logs, very complicated procedure is sometimes required.

A technique described in the first embodiment can be used for dynamically inserting a process of a diagnostic program into an arbitrary point (diagnostic position) of a program that is being executed. The diagnostic program can refer to values of variables of the program of the diagnostic target. After the process of the diagnostic program ends, process returns to the position at which the process of the diagnostic program is inserted in the diagnostic target program. According to this technique, it becomes possible to output logs of the program of the diagnostic target by using the diagnostic program without modifying source code of the program of the diagnostic target.

However, since the diagnostic program may be applied to any program, there is a possibility that a diagnostic program created by a party that is not a developer or a maintenance worker of the program (application) of the target. As a result, not only is there a possibility that the operation of the applied program or the whole of the apparatus becomes unstable, but there is also a possibility that security is not properly maintained. In addition, when a plurality of diagnostic programs having an exclusive relationship with each other are executed at the same time, there is a possibility that intended operation cannot be performed for each diagnostic program.

In the following, techniques for solving the above problems are described as a second embodiment.

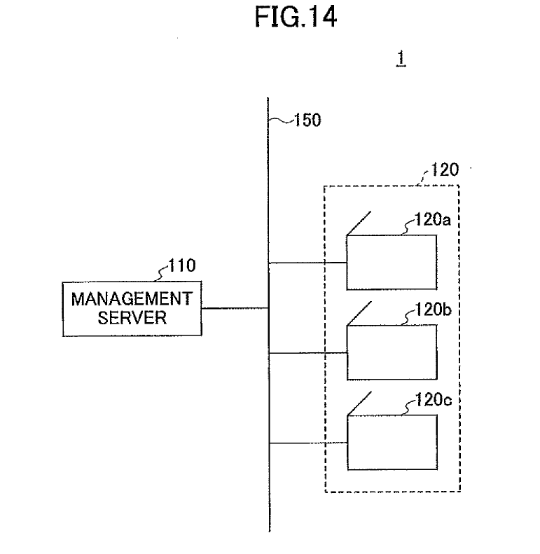

FIG. 14 is a diagram showing a configuration example of an apparatus management system according to a second embodiment of the present invention. In the image forming system shown in FIG. 14, a management server 110, an apparatus 120a, an apparatus 120b and an apparatus 120C (each of the are collectively called an apparatus 120) are connected via a network 150 (including wireless network and/or cable network) such as a LAN (Local Area Network) or the Internet.

The apparatus 120 is an image forming apparatus (multifunctional machine) realizing a plurality of functions such as copy function, printer function and scanner function in a body. The apparatus 120 includes a CPU and a memory to realize various functions based on control by the CPU according to the program stored in the memory. In the present embodiment, the apparatus 120 is an example of electronic apparatuses.

The management server 110 is computer for performing management of add programs to be applied to programs used in the apparatus 20, and performing transfer of the add programs to the apparatus 20, and the like. The add program of the present embodiment is similar to the add program described in the first embodiment as described in FIG. 2.

In the present embodiment, by using the add program, output of log information and function strengthening can be dynamically realized for a program of an application target without performing modification of source code, compile, link, re-install, and the like. The hardware configuration of the apparatus 20 of the present embodiment is similar to that of the first embodiment shown in FIG. 3.

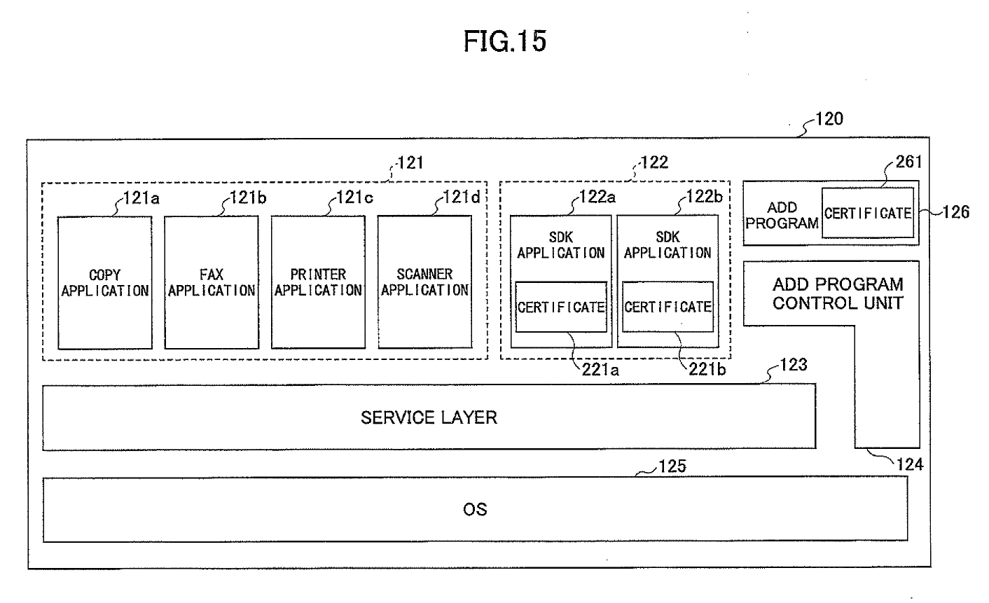

FIG. 15 is a diagram showing a software configuration example of the apparatus 120 of the second embodiment of the present invention. The apparatus 120 includes a standard application 121, an add program control unit 124, and an OS 125. The software is loaded on the RAM in the MEM-P 631, and executed by the CPU 611 so that the function is realized.

The standard application 121 is an application embedded at the factory as a standard function. As an example, the figure shows a copy application 121a, a FAX application 121b, a printer application 121c, and a scanner application 121d as the standard application 121.

The copy application 121a is an application for realizing copy function. The FAX application 121b is an application for realizing FAX function. The printer application 121c is an application for realizing print function. The scanner application 121d is an application for realizing scanner function.

The SDK application 122 is an application using a SDK (software development kit) specific for the apparatus 120. More particularly, a part of APIs (Application Program Interface) of the service layer 23 is disclosed. So, the SDK application 122 can be generated by a third vendor using the APIs. As an example, the figure shows SDK applications 122a and 122b. Each SDK application 122 is provided with a certificate (digital certificate), or a certificate is associated with each SDK application. For example, a certificate 221a is added to the SDK application 122a, and a certificate 221b is added to the SDK application 122b (in the following, these are collectively referred to as “certificate 221). The certificate 221 includes owner information, public key, signature of a certificate authority, program ID and the like. The owner information is identification information of a creator (development vendor) of the SDK application 122 to which the certificate 221 is added. The program ID is an ID that can uniquely identify each SDK application 122.

The service layer 123 includes a program group for providing services (functions) commonly required for the application 121 to the application 121. For example, the service layer 123 includes a program for mediating network communication, a program for controlling hardware such as the image taking unit 604 and the print unit 605 and the like, a program for managing a storage device such as a memory and a hard disc drive, and a program for controlling the operation panel 602, and the like.

The OS 125 is a so called OS (Operating System). The OS 125 is not limited to a particular one.

The add program control unit 124 is software for performing execution control for the add program 126. For example, the add program control unit 124 downloads the add program 126, and applies the add program 126 to an application target. As shown in the figure, each add program 126 is accompanied by a certificate 261. The certificate 261 is a digital certificate, and includes owner information, public key, signature of certificate authority, and a program ID and the like. The owner information is identification information of a creator (development vendor) of the add program 126 to which the certificate 261 is added. The program ID is an ID for uniquely identifying each add program. The configuration of the certificate 261 is the same as that of the certificate 221 for the SDK application 122. But, they are not necessarily the same.

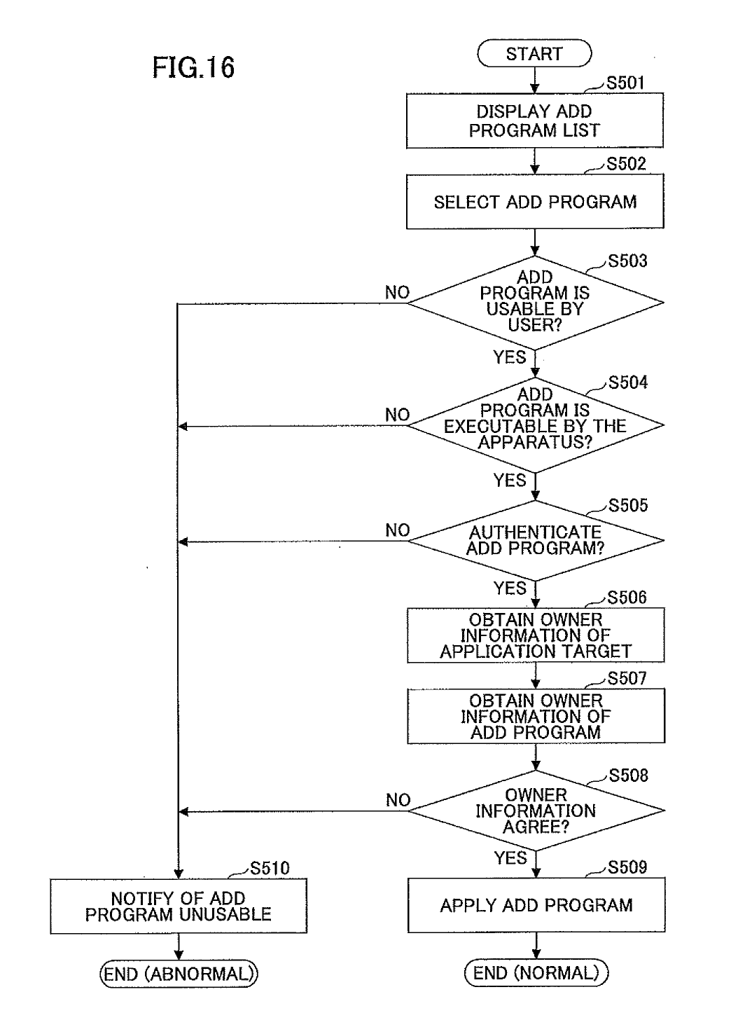

In the following, a processing procedure of the apparatus 120 is described. FIG. 16 is a flowchart for explaining processes for applying the add program according to a first example. In the process shown in the figure, user authentication has been performed. That is, each program of the apparatus 120 can identify a user (current user) who is currently operating the apparatus 120.

In response to operation input by the user via the operation panel 602, the add program control unit 124 obtains list information of the add programs managed by the management server 110 from the management server 110, and causes the operation panel 602 to display the list information in step S501.

When an add program 126 is selected from among the list information by the user in step S502, the add program control unit 124 downloads the selected add program 126 from the management server 110, and checks presence or absence of use authority of the current user for the add program 126 (to be referred to as “current add program 126” hereinafter) in step S103. The check of presence or absence of the use authority can be performed based on pre-defined access control information for the add program 126. In the access control information, user names who can use add program may be defined for each add program, or program names (file names) or program IDs of usable add programs 126 may be defined for each user. Or, the access control information may be information for identifying users who can use add program 126 from users who cannot use add programs 126. The access control information may be stored in the EDD 633 of the apparatus 120 or may be stored in the management server 110.

When the current user has the use authority (Yes in step S503), the add program control unit 124 determines whether the current add program 126 can be executed on the apparatus 120 in step S504. The determination corresponds to determination for determining whether the current add program 126 can be executed in an environment of program execution in the apparatus 120. For example, attribute information of the add program 126 includes the model of the apparatus 120, version of the service layer 123, and version of the OS 125 by which the add program 126 can operate, and it is determined whether the environment of the apparatus 120 corresponds to the information (model, version and the like). The attribute information of the current add program 126 can be downloaded from the management server 110 with the current add program 126.

When the current add program 126 is executable on the apparatus 120 (Yes in step S504), the add program control unit 124 performs authentication process (verification of validity) for the current add program 126 based on the certificate 261 in step S505. Authentication of the program based on the digital certificate can be performed using a general method.

When the current add program 126 is authenticated (Yes in step S505), the add program control unit 124 obtains owner information from the certificate 221a of the SDK application 122 (SDK application 122a in this example) to which the current add program 126 is to be applied in step S506. Information for identifying a program to which the current add program 126 is to be applied is included in the add program 126 as a format that the add program control unit 124 can interpret. Therefore, the add program control unit 124 can determine that the SDK application 122a is an application to which the current add program 126 is to be applied.

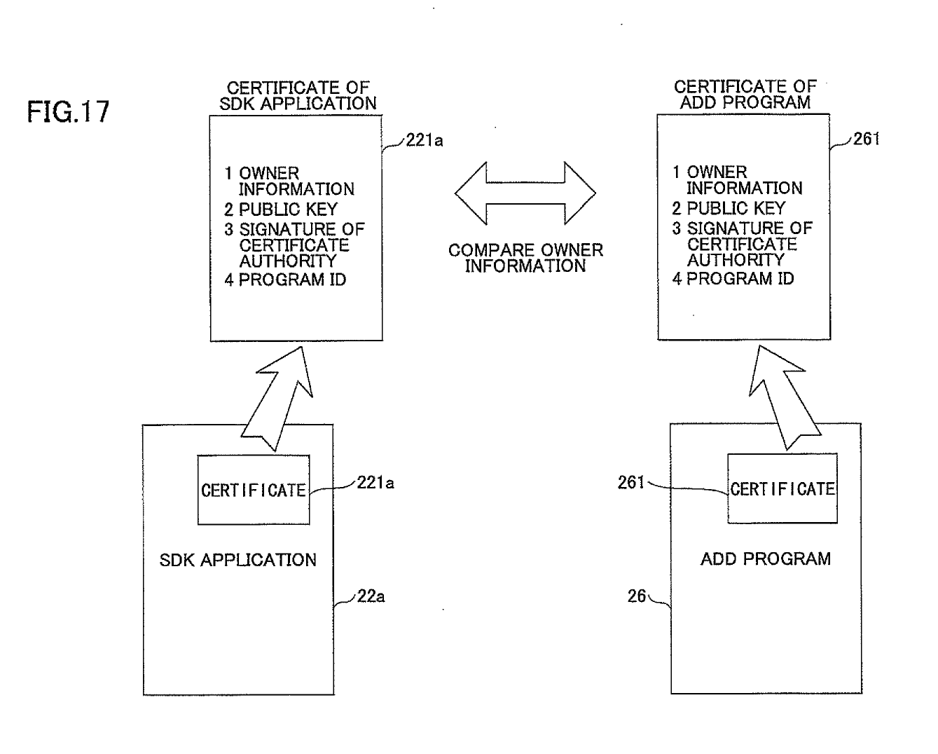

Next, the add program control unit 124 obtains owner information from the certificate 261 of the current add program 126 in step S507. Next, as shown in FIG. 17, the add program control unit 124 compares the owner information of the application target with the owner information of the current add program 126 in step S508. When they are the same (Yes in step S508), the add program control unit 124 applies the current add program 261 to the SDK application 122a which is the application target in step S509. More particularly, when execution step in the SDK application 122a reaches a position (add position) specified in the current add program 126, the add program control unit 124 executes (inserts) the process of the add program 126.

On the other hand, when the current user does not have use authority of the current add program 126 (No in step S503), when the current program is not executable on the apparatus 120 (No in step S504), when authentication of the current add program 126 fails (No in step S505) or when the owner information of the application target is not the same as the owner information of the current add program 126 (No in step S508), the add program control unit 124 does not apply the current add program 126, and causes the operation panel 602 to display a message indicating that the current add program 126 cannot be used in step S510.

As mentioned above, according to the first example, when the owner information of the application target does not agree with the owner information of the add program 126, the add program 126 is not executed. Therefore, the add program 126 developed by a development vendor is prevented from being easily applied to a SDK application 122 developed by other development vendor.

Next, a second example is described. In the second example, different points compared with the first example are described. Points that are not particularly mentioned are similar to the first example.

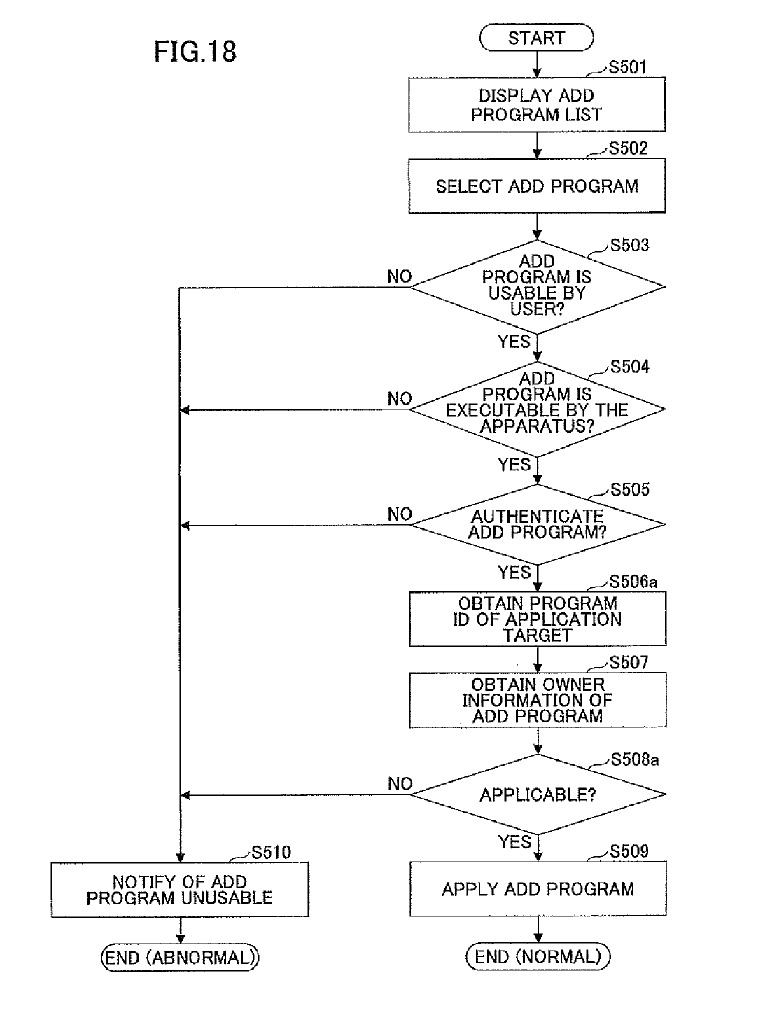

FIG. 18 is a flowchart for explaining processes for applying the add program in the second example. In FIG. 18, same step numbers are assigned to corresponding steps in FIG. 16.

As shown in FIG. 18, step S506 is replaced with step S506a, and step S508 is replaced with step S508a. In step S506a, the add program control unit 124 obtains the program ID from the certificate 221a of the SDK application 122a to which the current add program 122a is applied. Next, the add program control unit 124 obtains owner information from the certificate 261 of the current add program 126 in step S507. Next, the add program control unit 124 determines availability of application of the current add program 126 by referring to an application availability determination table in step S508a.

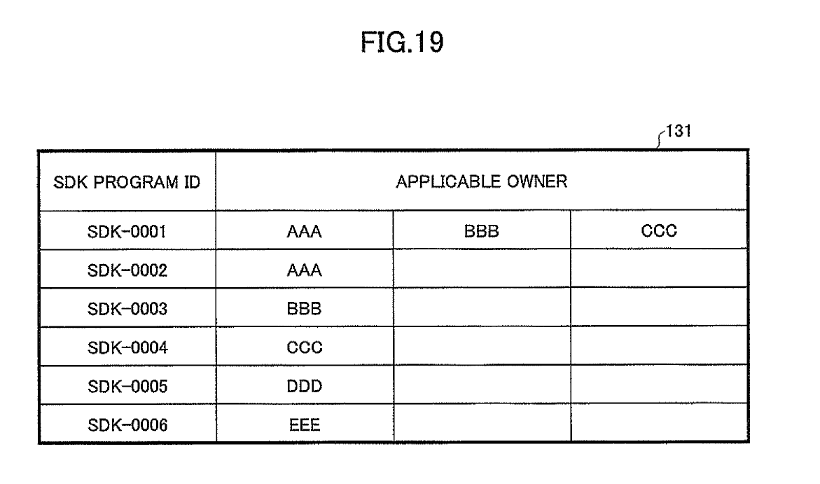

FIG. 19 is a diagram showing a configuration example of the application availability determination table. As shown in the figure, the application availability determination table 131 includes owners of add programs that can be applied for each corresponding program ID of the SDK application 122. In the example shown in the figure, it is defined that each add program 126 corresponding to owner information of “AAA”, “BBB” or “CCC” can be applied to the SDK application 122 having a program ID of “SDK-0001”. The application availability determination table 131 may be stored in the HDD 633 of the apparatus 120 or may be stored in the management server 110. In addition, the application availability determination table 131 can be configured to be editable only by a predetermine person such as a manager.

Therefore, the add program control unit 124 searches the application availability determination table 131 for the program ID (program ID of application target) obtained in step S506a to determine owner information of add programs that can be applied. Then, the add program control unit 124 determines whether owner information of the obtained current add program 126 obtained in step S507 is included in the owner information obtained in step S506a in order to determine whether the current add program 126 can be applied to the target program. When the owner information obtained in step S506a includes owner information of the current add program 126 (Yes in step S508a), the add program control unit 124 applies the current add program 126 to the SDK application 122a in step S509.

When the applicable owner information does not include owner information of the current add program 126 (No in step S508a), the add program control unit 124 does not apply the current add program 126 in step S510.

As mentioned above, according to the second example, the availability of the application of the add program 126 is determined based on the application availability determination table 131. Therefore, even though owner information (development vendor) of the SDK application 122 and owner information (development vendor) of the add program 126 are different from each other, the add program 126 can be applied. Thus, compared with the first example, flexibility for applying the add program 126 improves.

The application availability determination table 131 may include a correspondence relationship between the SDK application 122 and the add program 126 instead of the correspondence relationship between the SDK application 122 and owner information of the add program 126. More particularly, the application availability determination table 131 may include program IDs of applicable add programs 26 for each program ID of the SDK application 22. In this case, in step S507, the add program control unit 124 obtains the program ID of the current add program 126 from the certificate 261 to perform determination in step S508a using the program ID. In this case, it is necessary to update the application availability determination table 131 each time when the add program 126 is generated. Therefore, from the viewpoint of stability (reduction of maintenance work) of the application availability determination table 131, the example shown in FIG. 19 is preferable.

Pursuing that viewpoint, the application availability determination table 131 may include correspondence relationship between owner information of the SDK application 122 and owner information of the add program 126. In this case, since necessity for changing the application availability determination table 131 is low unless a new owner (development vendor) is added, stability of the application availability determination table 131 can be further increased.

Next, a third example is described. In the third example, different points compared with the first example are described. Points that are not particularly mentioned are similar to the first example.

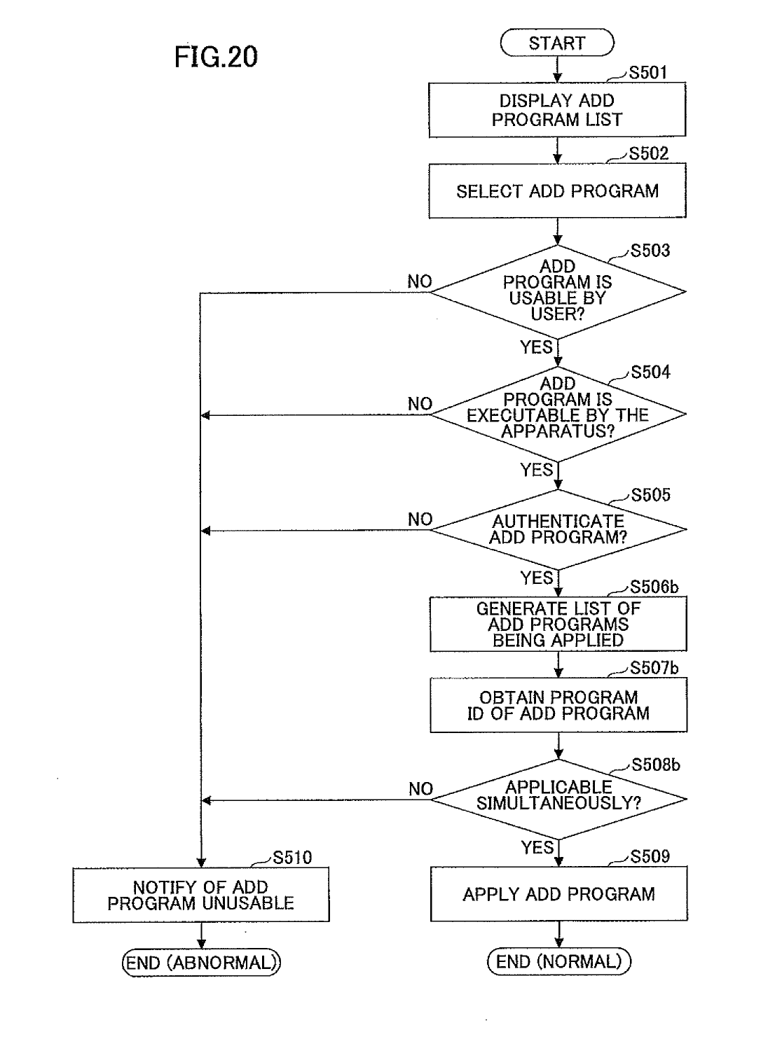

FIG. 20 is a flowchart for explaining processes for applying the add program in the third example. In FIG. 20, same step numbers are assigned to corresponding steps of FIG. 16.

In the figure, steps S506, S507 and S508 are replaced with steps S506b, S507b and S508b respectively. In step S506b, the add program control unit 124 generates a list of program IDs of add programs 126 that are currently being applied (already applied) Since the add program control unit 124 is a program for controlling execution of the add program 126, the add program control unit 124 ascertains program IDs of the add programs currently being applied.

Next, the add program control unit 124 obtains the program ID from certificate 261 of the current add program 126 to be applied from now on in step S507b. Next, the add program control unit 124 determines availability of application of the current add program 126 by referring to an exclusive relationship management table in step S508b.

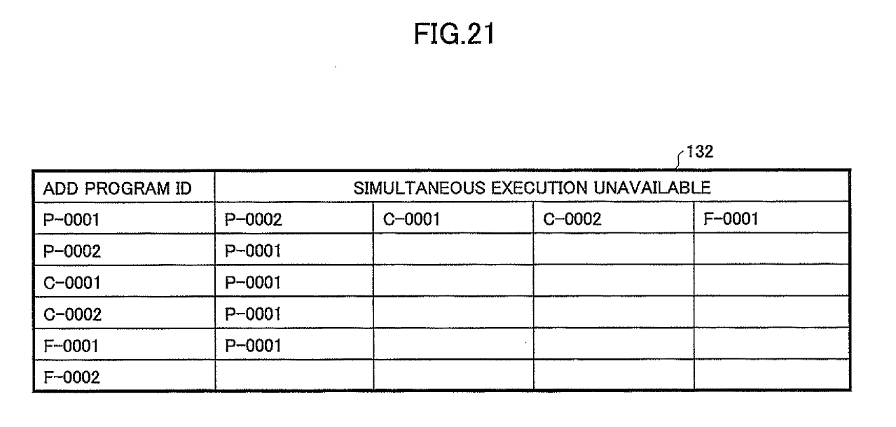

FIG. 21 is a diagram showing a configuration example of the exclusive relationship management table. As shown in the figure, the exclusive relationship management table 132 includes (registers) program IDs of add programs having an exclusive relationship with respect to execution time for each program ID of the add programs 126. The programs having an exclusive relationship with each other with respect to execution time cannot be executed simultaneously, or it is not preferable to execute the programs simultaneously. For example, the figure shows that the add program 126 of a program ID: P0001 has an exclusive relationship with add programs 126 of program IDs: P0002, C0001, C0002 and F0001. The exclusive relationship management table 132 may be stored in the HDD 633 of the apparatus 120 or in the management server 110. In addition, the exclusive relationship management table 132 may be configured editable by a predetermined person such as a manager.

Thus, the add program control unit 124 obtains, from the exclusive relationship management table 132, a program ID of an add program 126 having an exclusive relationship with the program ID of the current add program 126 obtained in step S507b. Then, the add program control unit 124 determines availability of application by determining whether at least one of program IDs obtained from the table 132 is included in the list of program IDs of the add programs 126 that are currently being applied, as generated in step S506b. When any of the program IDs having the exclusive relationship is not included in program IDs of programs currently being executed (Yes in S508b), the add program control unit 124 applies the current add program 126 to the SDK application 122a that is the application target in step S509.

When a program ID having the exclusive relationship is included in the program IDs of programs that are currently being executed (No in S508b), the add program control unit 124 does not apply the current add program 126 in step S510.

In the above-mentioned embodiment, an example is described in which the exclusive relationship management table 132 manages information indicating exclusive relationship. However, the exclusive relationship management table 132 may include information indicating relationship of programs that can be executed simultaneously. Even when the exclusive relationship management table 132 is configured like this, it is possible to determine exclusive relationship.

As mentioned above, according to the third example, it can be properly avoided that mutually exclusive add programs 126 are executed in parallel (simultaneously). Thus, the apparatus 120 can be prevented from invalidly operating due to parallel execution of add programs 126 having exclusive relationship with each other. As an example, add programs having the same application target have the exclusive relationship with each other. As another example, add programs accessing a same parameter of the apparatus 20 have the exclusive relationship with each other. However, satisfying the above-mentioned conditions does not necessarily mean satisfying exclusive relationship. For example, even when add programs have a same application target, there is a possibility that the add programs do not have the exclusive relationship if the application target can insert processes without interference between the add programs.

The third example may be carried out by combining with the first example or the second example in the second embodiment. Accordingly, application and execution of add programs 126 can be controlled based on combinations of relationship of programs of application target and add programs 126 and relationship between add programs 126.

The features of the second embodiment can be represented by the following configurations.

The electronic apparatus of this embodiment can be configured to include: a determination unit configured to determine availability of application of a second program based on whether second data has a pre-defined correspondence relationship with first data, wherein the second data is associated with the second program that can dynamically insert a process into a first program that is a target of application of the second program, and wherein the first data is associated with the first program; and an execution control unit configured to execute the second program by applying the second program to the first program according to the determination result of the determination unit.

According to the configuration, execution of the add program can be properly controlled.

As an example, the first data is data indicating a creator of the first program and the second data is data indicating a creator of the second program, and the determination unit determines that the second program can be applied when the first data agrees with the second data.

As an example, the first data are program identifiers each of which identifies one of a plurality of first programs, and the second data is data indicating a creator of the second program, and the electronic apparatus further includes a management unit configured to manage correspondence information for determining applicable corresponding relationship between the program identifiers and the creator, and the determination unit determines availability of application of the second program based on the first data, second data and the correspondence information.

As an example, the first data are program identifiers each of which identifies one of a plurality of first programs, and the second data are program identifiers each of which identifies one of a plurality of second programs, and the electronic apparatus further including a management unit configured to manage correspondence information for determining applicable corresponding relationship between the program identifiers of the first program and the program identifiers of the second program, and the determination unit determines availability of application of the second program based on the first data, second data and the correspondence information.

As an example, the first data is data indicating a creator of the first program and the second data is data indicating a creator of the second program, and the electronic apparatus further including a management unit configured to manage correspondence information for determining applicable corresponding relationship between the creator of the first program and the creator of the second program, and the determination unit determines availability of application of the second program based on the first data, second data and the correspondence information.

The electronic apparatus can be also configured to include: a management unit configured to manage correspondence information for determining exclusive relationship with respect to execution time among a plurality of second programs each of which can insert a process into a first program of an application target; a determination unit configured to determine whether a second program that is currently being applied has an exclusive relationship with a second program to be applied based on the correspondence information; and execution control unit configured to execute the second program to be applied by applying the second program to the first program according to the determination result of the determination unit.

The present invention is not limited to the specifically disclosed embodiments, and variations and modifications may be made without departing from the scope of the present invention.

The present application contains subject matter related to Japanese patent application No. 2008-084508, filed in the JPO on Mar. 27, 2008, and Japanese patent application No. 2008-121566, filed in the JPO on May 7, 2008, the entire contents of which being incorporated herein by reference.

What is claimed is:

1. An image forming apparatus comprising:
a job reception unit configured, in response to an execution request for a job, to receive a second program in which an insertion process for a first program that executes the job is described or to receive identification information of the second program;
an application unit configured to apply the second program to the first program loaded in a memory; and
a job execution unit configured to execute the job based on the first program to which the second program is applied.

2. The image forming apparatus as claimed in claim 1, comprising:
a release unit configured to release application of the second program to the first program according to completion of the job.

3. The image forming apparatus as claimed in claim 1, wherein, when another job is being executed based on the first program, the application unit waits for applying the second program until the other job completes.

4. The image forming apparatus as claimed in claim 1, wherein the job reception unit receives job data including the second program or the identification information of the second program from a computer connected via a network.

5. The image forming apparatus as claimed in claim 1, comprising:
a list displaying unit configured to receive list information of the second program from a computer connected via a network and to cause an operation panel to display the list information,
wherein the job reception unit receives the identification of the second program after the second program is selected from among the list information.

6. An information processing apparatus for requesting an image forming apparatus connected via a network to execute a job, comprising:
a setting screen displaying unit configured to display a screen for inputting settings for the job; and
a job data sending unit configured to send job data to the image forming apparatus, wherein the job data includes the settings input via the setting screen, and includes a second program in which an insertion process for a first program that executes the job in the image forming apparatus is described or identification information of the second program.

7. An information processing method performed in an image forming apparatus comprising:
in response to an execution request for a job, receiving a second program in which an insertion process for a first program that executes the job is described or receiving identification information of the second program;
applying the second program to the first program loaded in a memory; and
executing the job based on the first program to which the second program is applied.

8. The information processing method as claimed in claim 7, comprising:
releasing application of the second program to the first program according to completion of the job.

9. The information processing method as claimed in claim 7, wherein, when another job is being executed based on the first program, the image forming apparatus waits for applying the second program until the other job completes.

10. The information processing method as claimed in claim 7, wherein the step of receiving includes receiving job data including the second program or the identification information of the second program from a computer connected via a network.

11. The information processing method as claimed in claim 7, comprising:
receiving list information of the second program from a computer connected via a network in order to cause an operation panel to display the list information,
wherein the step of receiving the second program includes receiving the identification of the second program after the second program is selected from among the list information.
